(19) United States
(12) Patent Application Publication
(10) Pub. No.: US 2017/0218634 A1
(43) Pub. Date: Aug. 3, 2017

(54) GUTTER CLEANING SYSTEM

(71) Applicant: Marvin Thomas, St. Louis, MO (US)

(72) Inventor: Marvin Thomas, St. Louis, MO (US)

(21) Appl. No.: 15/010,143

(22) Filed: Jan. 29, 2016

(51) Int. Cl. E04D 13/076; B08B 9/032

(52) U.S. Cl. CPC E04D 13/0765; B08B 9/0328

(57) ABSTRACT

A gutter cleaning system is disclosed which has an air line for receiving air, a first section having a first end and a second end, the first end adapted to being connected to the air line, the first section having an aperture formed therein, and a head assembly connected to the second end of the first section, the head assembly having an arm portion having an aperture.

### BACKGROUND

This disclosure relates generally to a gutter cleaning system, and more particularly to a gutter cleaning system that is capable of automatically cleaning rain gutters attached to a structure.

Rain gutter systems are attached to dwellings, homes, and other structures for removing rain water from a roof to deposit rain water away from the structure. Providing a dedicated path of rain water flow helps to prevent soil erosion around the structure, protects the foundation of the structure, and prevents leaks in basements. The rain gutter system typically consists of a horizontal gutter section that is used to collect rain water, a vertical downspout connected to the gutter to remove the rain water from the gutter, and an elbow to direct rain water away from the downspout. Over time, debris may accumulate in the horizontal gutter. Debris, such as leaves, dirt, rocks, paper, birds, bird droppings, tennis balls, may clog the gutter and cause various problems. In particular, debris may quickly decompose and clog not only the horizontal gutter section but also the downspout. Accumulated debris may be a fire hazard and may lead to premature wear of roof shingles when water is backed up under the shingles. Due to the gutter being clogged, water may cascade over the edge of the gutter and cause soil erosion and water leakage defeating the purpose of the gutter. Other damage caused by clogged gutters may include foundation cracking and settling, dry-rot on fascia boards, soffit, and roof, paint damage, window, door and siding damage, and mold damage. As can be appreciated, being able to prevent clogging of the gutter is important in prolonging the life of a structure being protected by the gutter.

One known way to clean a gutter is to have an individual climb a ladder and manually clean out the gutter of any debris. Cleaning by this method may be dangerous in that the individual may fall off the ladder, require numerous attempts to clean the gutter, and may require multiple trips up and down the ladder. Other complex gutter cleaning systems and devices have been proposed, but such systems and devices are difficult to install, are difficult to maintain, are labor intensive, and are expensive. In an attempt to prevent clogging some manufacturers have developed leaf guards or screens which consists of either a metal grating or screen that is placed over the horizontal gutter section or a metal cap that allows only water to enter into the horizontal gutter section. Although these devices appear to solve the problem of debris accumulation, it is known that debris can cover the metal grating or the metal cap allowing water to cascade over the gutter leading to soil erosion or water damage.

The present disclosure is designed to obviate and overcome many of the disadvantages and shortcomings experienced with prior gutter cleaning systems or methods. Moreover, the present disclosure is related to a gutter cleaning system that can be easily operated or employed to remove debris from gutters. The gutter cleaning system of the present disclosure is also simple to use due to remote operation of the system. Further the gutter cleaning system of the present disclosure does not require any moving parts to clean gutters.

### SUMMARY

In one form of the present disclosure, a gutter cleaning system is disclosed which comprises an air line for receiving air, a first section having a first end and a second end, the first end adapted to being connected to the air line, the first section having an aperture formed therein, and a head assembly connected to the second end of the first section, the head assembly having an arm portion having an aperture.

In another form of the present disclosure, a gutter cleaning system comprises an air line for receiving air, a first section having a first end and a second end, the first end adapted to being connected to the air line, the first section having an aperture formed therein, a head assembly connected to the second end of the first section, the head assembly having an arm portion having an aperture formed therein, and a clip for securing the first section to a gutter.

In still another form of the present disclosure, a gutter cleaning system comprises an air line having a first end and a second end with the first end for receiving air, an elbow connector having a first end and a second end with the first end adapted to being connected to the second end of the air line, a first section having a first end and a second end, the first end adapted to being connected to the second end of the elbow, the first section having an aperture formed therein, a tee connector having a first end, a second end, and a third end, the first end adapted to being connected to the second end of the first section, a head assembly connected to the second end of the tee connector, the head assembly having an arm portion having an aperture formed therein, a second section having a first end and a second end, the first end adapted to being connected to the third end of the tee connector, the second section having an aperture formed therein and an end cap for covering the second end of the second section.

In light of the foregoing comments, it will be recognized that the gutter cleaning system of the present disclosure is of simple construction and design and which can be easily employed with highly reliable results.

The present disclosure provides a gutter cleaning system that can be operated automatically to clean gutters.

The present disclosure provides a gutter cleaning system that is easy to use, store, and transport to an installation site.

The present disclosure provides a gutter cleaning system that is lightweight, compact, and durable.

The present disclosure also provides a gutter cleaning system that can be constructed using readily available materials and components.

The present disclosure also provides a gutter cleaning system that allows an interior of a gutter to be cleaned and a top of a gutter having a leaf guard to be cleaned.

The present disclosure is also directed to a gutter cleaning system that does not require an individual to be near the gutter to clean the gutter.

The present disclosure further provides a gutter cleaning system that may be easily configured and installed to clean gutters of different shapes, sizes, and lengths.

The present disclosure is also directed to a gutter cleaning system that may comprised component parts that may be installed in sections to accommodate and clean gutters of different lengths.

The present disclosure provides a gutter cleaning system that may be installed by a professional or by a homeowner and does not require any specialized tools or training to install the gutter cleaning system.

The present disclosure is further directed to a gutter cleaning system that may be quickly installed on a structure, such as a house, by using commonly available tools and equipment.

These and other advantages of the present disclosure will become apparent after considering the following detailed specification in conjunction with the accompanying drawings, wherein:

### BRIEF DESCRIPTION OF THE DRAWINGS

FIG. 1 is a partial perspective view of a gutter cleaning system constructed according to the present disclosure being installed on a structure;

FIG. 2 is a partial perspective view of another embodiment of a gutter cleaning system constructed according to the present disclosure being installed on a house;

FIG. 3 is a partial perspective view of a section of the gutter cleaning system constructed according to the present disclosure removed from a house; and

FIG. 4 is a partial side view of a head assembly of the gutter cleaning system constructed according to the present disclosure.

### DETAILED DESCRIPTION OF THE PREFERRED EMBODIMENTS

Referring now to the drawings, wherein like numbers refer to like items, number 10 identifies a preferred embodiment of a gutter cleaning system constructed according to the present disclosure. Referring now to FIG. 1, the gutter cleaning system 10 is shown to comprise an air line 12 for receiving air, such as pressurized air, a first section or tubing 14 having a first end 16 and a second end 18 with the first end 16 adapted to being connected to the air line 12 and the first section 14 having one or more apertures 20 formed therein, and a head assembly 22 connected to the second end 18 of the first section 14, the head assembly 22 having an arm portion 24 having one or more apertures 26. The air line 12 is connected to a source of air, such as an air compressor 28. The air line 12 may also have a shut-off valve 30 connected between the compressor 28 and the first section 14 for selectively closing any air flow from the compressor 28, as may be required. The first section 14 and the head assembly 22 may be positioned on and in a gutter 32 that is connected to a structure 34, such as a house or a building. The first section 14 may have one or more clip devices 36 or other attaching or securing devices at various locations or positions along the first section 14 to hold the first section 14 in position relative to the gutter 32. It is also contemplated that the clips 36 may be attached to the gutter 32 or the structure 34 or both. Although not shown in this particular view, the gutter 32 may have a screen or other device mounted to the gutter 32 to attempt to keep debris out of the gutter 32. The first section 14 may also have more head assemblies 38 positioned along the first section 14 as need be. The head assembly 38 has an arm portion 40 that extends from the first section 14 with the arm portion 40 having apertures 42. The gutter cleaning system 10 may be incorporated into the structure 34 for various reasons, such as for aesthetics. Additionally, although the gutter cleaning system 10 is shown as a unitary construction it is also possible that the gutter cleaning system 10 may be comprised of various components or parts as will be explained further herein.

As can be appreciated, in operation the air compressor 28 is turned on to provide compressed air through the shut off valve 30, the air line 12, the first section 14 out through the apertures 20 in the first section 14 and the apertures 26 and 42 of the head assemblies 22 and 38. The compressed air is capable of moving any debris in the gutter 32 down or out of the gutter 32 by use of the head assemblies 22 and 38. Also, if the gutter 32 is fitted with a screen or other type device then the compressed air flowing through the apertures 20 will blow any debris on the screen off of the screen and away from the gutter 32. The air line 12 and the first section 14 may be any length that is required to clean any length of the gutter 32. The air compressor 26 may be positioned at a remote location or within the structure 34. Although not shown, the air compressor 28 may be connected to a timer, or a computer, or a WiFi connected device for selectively or automatically operating the gutter cleaning system 10. For example, the gutter cleaning system 10 may be programmed to run twice a day for a predetermined period of time in order to clean the gutter 32. It is also possible that the gutter cleaning system 10 may have an app or other software program so that the system 10 may be operated from a smartphone. The air compressor 28 may be a commercially available device that is used to produce compressed air. By way of example only, the volume of air delivered may be from 10 to 40 cubic feet per minute (cfm) and the amount of pressure that the compressor 28 is able to develop is 50 to 250 pounds per square inch (psi). The air line 12 and the first section 14 may be a plastic or rubber tubing or air hose that is capable of withstanding 250 to 500 pounds of pressure per square inch. By way of example only, PEX tubing may be used for the air line 12 and the first section 14. PEX tubing is a cross-linked polyethylene pipe manufactured using extrusion method. PEX tubing or pipe is cost-effective, flexible, durable, and easy to install.

FIG. 2 illustrates another embodiment of a gutter cleaning system 100 being installed on a house 102 having a gutter 104, a down spout 106, and siding 108. The gutter 104 also has a screen 110 that is used to cover the gutter 104 to prevent large objects, debris, and leaves from entering into the gutter 104. As has been previously indicated, the gutter 104 may have other caps or guard devices that prevent debris from entering into the gutter 104. The gutter cleaning system 100 comprises an air line 112 having a first end 114 and a second end 116 with the first end 114 for receiving air from an air compressor (not shown) that may be positioned within the house 102. The air line 112 may also have a shut off valve (not shown) such as the shut off valve 30 shown in FIG. 1. The gutter cleaning system 100 may also have a controller (not shown) connected near the air compressor that may automatically or selectively control operation of the gutter cleaning system 100. An elbow connector 118 is provided having a first end 120 and a second end 122 with the first end 120 adapted to being connected to the second end 116 of the air line 112. A first clamp member or device 124 is used to connect the second end 116 of the air line 112 to the first end 120 of the elbow connector 118. A first section 126 of tubing, such as a plastic or rubber tubing, has a first end 128 and a second end 130 with the first end 128 adapted to being connected to the second end 122 of the elbow connector 118. The first section 126 has a number of apertures 132 formed therein. The first end 128 of the first section 126 is connected to the second end 122 of the elbow connector 118 by use of a second clamp member or device 134. A clip device or connector 136 is used to connect the first section 126 in place to either the house 102 or the gutter 104. Although one clip device 136 is shown, it is possible that more than one clip device 136 may be used to secure the first section 126 in place. It is also contemplated that other securing devices or adhesives may be used to secure the first section 126 in place. A tee connector 138 is used to connect the first section 126 to a second section 140 of tubing and a head assembly (not shown). The second section 140 has a first end 142, a second end 144, and a plurality of apertures 146 formed therein. A pair of clamp members or devices 148 and 150 are used to secure the tee connector 138 to the first section 126 and the second section 140.

The gutter cleaning system 100 may operate in the following manner. The air compressor (not shown) is turned on to provide compressed air through the shut off valve, if present, the air line 112, the elbow connector 118, the first section 126, the tee connector 138, the head assembly (not shown), and the second section 140. Compressed air is allowed to flow out of the apertures 132 in the first section 126 and the apertures 146 of the second section 140. Compressed air that flows out of the apertures 132 and 146 are used to move debris on the screen 110 away from the screen 110 and the gutter 104. As will be discussed further herein, compressed air is capable of moving any debris in the gutter 104 down or out of the gutter 104 by use of the head assembly (not shown). The air line 112, the first section 126, and the second section 140 may be any length that is required to clean any length of the gutter 104. Although not shown, it is possible that a number of first sections 126, second sections 140, tee connectors 138, head assemblies, and clip devices 136 may be used depending on the length of the gutter 104. In essence, the gutter cleaning system 100 may be scaled to any size of gutter 104. Due to the system 100 being capable of being scaled, this provides for the system 100 to be installed by either a professional or a homeowner. It is also possible that the system 100 may be provided in a kit form to be installed by a homeowner. Although the air line 112 is shown running along an exterior side of the house 102, it is possible that the air line 112 may be inserted or hidden within the house 102. The air compressor may be positioned at a remote location or within the house 102. Although not shown, the air compressor may be connected to a timer, or a computer, or a WiFi connected device for selectively or automatically operating the gutter cleaning system 100. For example, the gutter cleaning system 100 may be programmed to run twice a day for a predetermined period of time in order to clean the gutter 104. As has been indicated, it is also possible that the gutter cleaning system 100 may have an app or other software program so that the system 100 may be operated from a smartphone.

With reference now to FIG. 3, a partial end portion 200 of the gutter cleaning system 100 is shown. The end portion 200 has a first section 202 having a first end 204, a second end 206, and a plurality of apertures 208. A tee connector 210 has a first end 212, a second end 214, and a third end 216 with the first end 212 adapted to being connected to the second end 206 of the first section 202 by use of a clamp member or device 218. The second end 214 of the tee connector 210 is connected to a head assembly 220 by use of a clamp member or device 222. The third end 216 of the tee connector 210 is connected to a first end 224 of a second section 226 of tubing by use of a clamp member or device 228. The second section 226 has a second end 230, a plurality of apertures 232, and an end cap 234 for capping or closing the second end 230. The end cap 234 may be a cap that is connected to the second end 230 that closes the second end 230 or may be formed as the end cap when constructing the second section 226. The end cap 234 prevents any compressed air from escaping the second end 230 of the second section 226 and insures that the compressed air is directed out of the apertures 232.

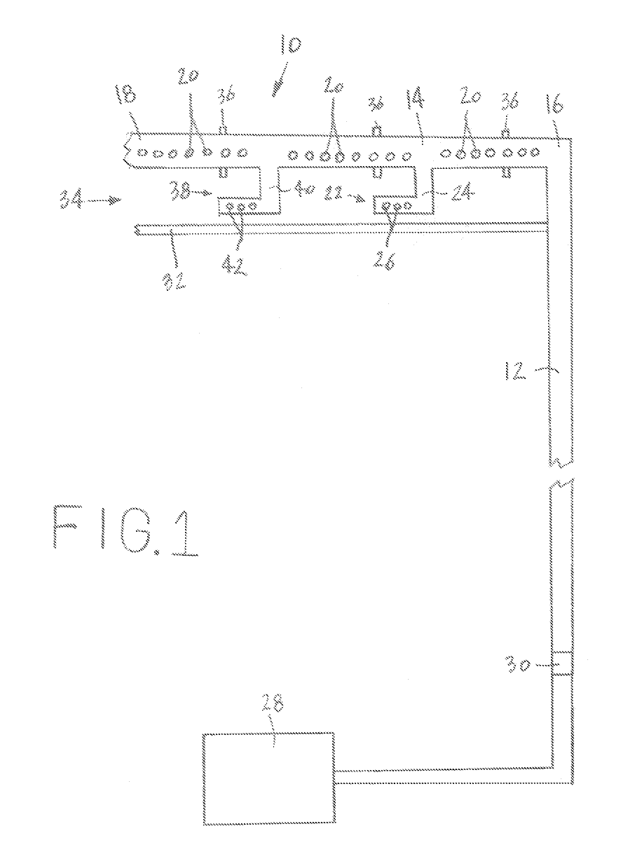

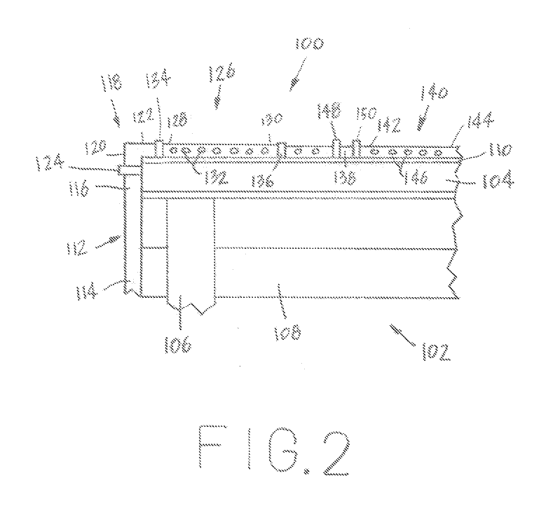

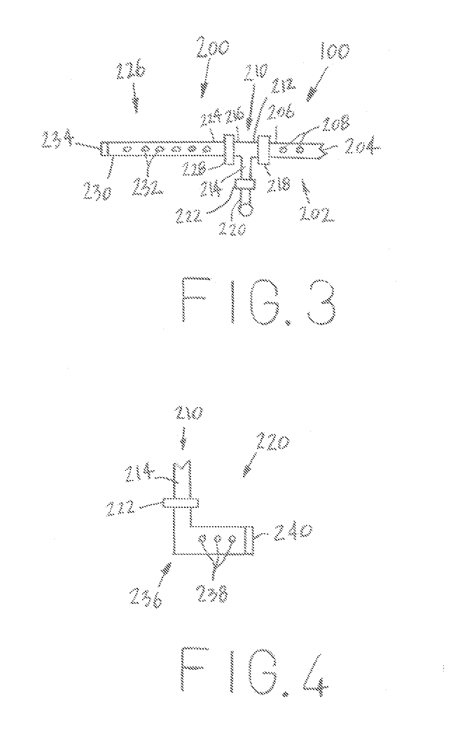

FIG. 4 depicts a partial side view of the head assembly 220 being connected to the second end 214 of the tee connector 210 by use of the clamp member 222. The head assembly 220 comprises an arm portion 236 having a plurality of apertures 238 formed therein and an end cap 240. The end cap 240 may be a cap that is connected to the arm portion 236 or may be formed as part of the arm portion 236 when constructing the arm portion 236. The end cap 240 insures that compressed air is directed out of the apertures 238 associated with the arm portion 236. In this manner, any debris that is in the gutter 104 (FIG. 2) will be moved within the gutter 104 and directed to the down spout 106 (FIG. 2) to be removed from the gutter 104. As can be appreciated, a number of head assemblies 220 may be provided in the gutter cleaning system 100 as needed to move debris in the gutter 104 along the length of the gutter 104 to the down spout 106.

From all that has been said, it will be clear that there has thus been shown and described herein a gutter cleaning system which fulfills the various objects and advantages sought therefor. It will be apparent to those skilled in the art, however, that many changes, modifications, variations, and other uses and applications of the subject gutter cleaning system are possible and contemplated. All changes, modifications, variations, and other uses and applications which do not depart from the spirit and scope of the disclosure are deemed to be covered by the disclosure, which is limited only by the claims which follow.

What is claimed is:

1. A gutter cleaning system comprising:
an air line for receiving air;
a first section having a first end and a second end, the first end adapted to being connected to the air line, the first section having an aperture formed therein; and
a head assembly connected to the second end of the first section, the head assembly having an arm portion having an aperture.

2. The gutter cleaning system of claim 1 wherein the air line is connected to an air compressor for providing compressed air through the air line, the first section, and the head assembly.

3. The gutter cleaning system of claim 1 further comprising a second section having a first end and a second end, the first end being adapted to being connected to the head assembly.

4. The gutter cleaning system of claim 3 wherein the second section further comprises an aperture formed therein.

5. The gutter cleaning system of claim 3 further comprising a second head assembly connected to the second end of the second section, the second head assembly having an arm portion having an aperture.

6. The gutter cleaning system of claim 1 wherein the air line comprises plastic tubing.

7. The gutter cleaning system of claim 1 wherein the first section and the head assembly each comprise plastic tubing.

8. A gutter cleaning system comprising:
an air line for receiving air;
a first section having a first end and a second end, the first end adapted to being connected to the air line, the first section having an aperture formed therein;
a head assembly connected to the second end of the first section, the head assembly having an arm portion having an aperture formed therein; and
a clip for securing the first section to a gutter.

9. The gutter cleaning system of claim 8 wherein the air line is connected to an air compressor for providing compressed air through the air line, the first section, and the head assembly.

10. The gutter cleaning system of claim 8 further comprising a second section having a first end and a second end, the first end being adapted to being connected to the head assembly.

11. The gutter cleaning system of claim 10 wherein the second section further comprises an aperture formed therein.

12. The gutter cleaning system of claim 10 further comprising a second head assembly connected to the second end of the second section, the second head assembly having an arm portion having an aperture formed therein.

13. The gutter cleaning system of claim 8 wherein the air line comprises plastic tubing.

14. The gutter cleaning system of claim 8 wherein the first section and the head assembly each comprise plastic tubing.

15. A gutter cleaning system comprising:
an air line having a first end and a second end with the first end for receiving air;
an elbow connector having a first end and a second end with the first end adapted to being connected to the second end of the air line;
a first section having a first end and a second end, the first end adapted to being connected to the second end of the elbow, the first section having an aperture formed therein;
a tee connector having a first end, a second end, and a third end, the first end adapted to being connected to the second end of the first section;
a head assembly connected to the second end of the tee connector, the head assembly having an arm portion having an aperture formed therein;
a second section having a first end and a second end, the first end adapted to being connected to the third end of the tee connector, the second section having an aperture formed therein and an end cap for covering the second end of the second section.

16. The gutter cleaning system of claim 15 further comprising a pair of clamp members with one of the clamp members for connecting the second end of the air line to the first end of the elbow connector and the other one of the clamp members for connecting the second end of the elbow connector to the first end of the first section.

17. The gutter cleaning system of claim 15 further comprising three clamp members with the first clamp member for connecting the first end of the tee member to the second end of the first section, the second clamp member for connected the second end of the tee member to the head assembly, and the third clamp member for connecting the third end of the tee member to the first end of the second section.

18. The gutter cleaning system of claim 15 wherein the first end of the air line is connected to an air compressor for providing compressed air through the air line, the elbow connector, the first section, the tee connector, the head assembly, and the second section.

19. The gutter cleaning system of claim 18 wherein the air line further comprises a shut off valve.

20. The gutter cleaning system of claim 15 further comprising a first clip for securing the first section to a gutter and a second clip for securing the second section to the gutter.
